(19) United States
(12) Patent Application Publication
(10) Pub. No.: US 2020/0399955 A1
(43) Pub. Date: Dec. 24, 2020

(54) BLIND BODY ACTUATOR FOR NON-CORD WINDOW BLIND ASSEMBLY

(71) Applicant: SHEEN WORLD TECHNOLOGY CORPORATION, TAICHUNG CITY (TW)

(72) Inventors: HUNG-HAO CHEN, TAICHUNG CITY (TW); MING-CHE TSAI, TAICHUNG CITY (TW)

(21) Appl. No.: 16/448,944

(22) Filed: Jun. 21, 2019

(51) Int. Cl. E06B 9/322; E06B 9/327; B65H 75/48

(52) U.S. Cl. CPC E06B 9/322; E06B 2009/3222; B65H 75/486; E06B 9/327

(57) ABSTRACT

A blind body actuator used in a non-cord window blind is provided to include a casing, a winding mechanism, a set of guide units, a set of lift-cord wheels, and a set of lift cords. The winding mechanism is rotatably mounted in the casing and includes a plurality of meshed and juxtaposed winding wheels and volute springs wound around the abovementioned winding wheels. The lift-cord wheels are meshed with the winding wheels and employed to wind the lift cords. The guide units contain some cylinder rollers that are employed for winding the lift cords based on actual needs.

### BACKGROUND OF THE INVENTION

### 1. Field of the Invention

The present invention relates to window blind technology and more particularly, to a blind body actuator for cordless window blind.

### 2. Description of the Related Art

Commercial window blinds can be classified into corded window blinds and cordless window blinds. The corded window blind uses a pull cord for pulling by a.

user to adjust the slats between an extended state and a received state, while the non-cord window blind uses manual power to upward push or downward pull the bottom rail, so that the blind body can be extended out or received.

It is known that Taiwan patent number: 263877 and patent number: 322458 describe improved actuator designs for lifting blind body of a window blind. However, the abovementioned designs are still complex in structure. Further, if the abovementioned designs are applied to large scale window blind, subject to the weight of its blind body, the blind body may not effectively and smoothly actuated.

### SUMMARY OF THE INVENTION

The present invention has been accomplished under the circumstances in view. It is an objective of the present to provide a blind body actuator for non-cord window blind, whose blind body can be effectively and smoothly actuated.

To achieve this and other objectives of the present invention, a blind body actuator for non-cord window blind is provide to comprise a casing, a winding mechanism, a set of lift-cord wheels, a set of guide units and a set of lift cords. The winding mechanism is rotatably mounted in the casing and comprises a first bottom winding wheel, a first upper winding wheel disposed on the first bottom winding wheel, a second bottom winding wheel meshed with the first bottom winding wheel, and a second upper winding wheel disposed on the second bottom winding wheel and meshed with the first upper winding wheel. The winding mechanism further comprising an upper volute spring and a bottom volute spring. The upper volute spring has two ends thereof connected with the first and second upper winding wheel respectively and it is capable of wound around the first upper winding wheel or the second upper winding wheel. The bottom volute spring has two ends thereof connected to the first and second bottom winding wheel respectively and it is capable of being wound around the first bottom winding wheel or the second bottom winding wheel.

The set of lift-cord wheels are rotatably mounted in the casing and they comprise a first lift-cord wheel and a second lift-cord wheel. The first lift-cord and the second lift-cord are respectively meshed with the first bottom winding wheel and the second bottom winding wheel.

The set of guide units are rotatably mounted in the casing and they comprise a first guide unit and a second guide unit. The first guide unit and the second guide unit are respectively disposed adjacent to the first lift-cord wheel and the second lift-cord wheel. The first and second guide units both comprise a first cylinder roller. Each of the first cylinder rollers, the first and second winding wheels, and the first and second lift-cord wheels has an axle respectively, and the axles of the first cylinder rollers, the first and second winding wheels, and the first amid second lift-cord wheels are parallel to each other; and

the set of lift cords comprise two first lift cords and two second lift cords. The two first lift cords and the two second lift cords are respectively wound around the first cylinder roller of the first guide unit and the first cylinder roller of the second guide unit respectively. Each of the two first lift cords has one end thereof connected to the first lift-cord wheel so that each of the first lift cords are capable of being wound around or unwound around the first lift-cord wheel by the rotation of the first lift-cord wheel. Each of said two second lift cords has one end thereof connected to the second lift-cord wheel so that each of the first lift cords are capable of being wound around or unwound around the second lift-cord wheel by the rotation of the second lift-cord wheel. Each of the first lift cords and the second lift cords has an opposite end thereof extended out of the casing.

The beneficiary effect of the present invention is as follows: the overall structural design of the blind body actuator is still simple. Further, when the blind body actuator is applied to large scale window blind, the blind body actuator can still effectively and smoothly actuate the blind body via the first and the second guide units.

In one aspect, the casing has a front side and a rear side. The two first cylinder rollers are disposed adjacent to the front side of said casing. Each of the first lift cords are wound around the first cylinder roller of the first guide unit through one turn and each of the second lift cords are wound around the first cylinder roller of the second guide unit through one turn.

In another aspect, both of the first and second guide units further comprise a second cylinder roller rotatably mounted in the casing. The casing has a front side and a rear side. The two first cylinder rollers and the two second cylinder rollers of the first and second guide units are respectively disposed adjacent to the front side and the rear side of the casing respectively. The two first lift cords are wound around the first cylinder roller of the first guide unit through half turn and then wound around the second cylinder roller of the first guide unit through half turn. The two second lift cords are wound around the first cylinder roller of the second guide unit through half turn and then wound around the second cylinder roller of the second guide unit through half turn.

In another aspect, the first guide unit and the second guide unit both further comprise a second cylinder roller and a third cylinder roller. The casing comprises a front side and a rear side. The two second cylinder rollers and the two third cylinder rollers are rotatably mounted in the casing. The two first cylinder rollers are mounted adjacent to the front side. The two second cylinder rollers and the two third cylinder rollers are juxtaposed and mounted adjacent to the rear side. The two first lift cords are wound around the first cylinder roller of the first guide unit through half turn, wound around the second cylinder roller of the first guide unit through half turn, and then wound around the third cylinder roller of the first guide unit through one turn. The two second lift cords are wound around the first cylinder roller of the second guide unit through half turn, wound around the second cylinder roller of the second guide unit through half turn, and then wound around the third cylinder roller of the second guide unit through one turn.

In another aspect, the casing comprises a left side and a right side, both of which has an opening and a cross bar disposed in the corresponding opening in such a manner that a center of the cross bar coincides with a center of the corresponding the opening. The two first lift cords are extended out of the casing through the opening and peripherally abutted against the center of the corresponding cross bar at the left side. The two second lift cords are extended out of the casing through the opening and peripherally abutted against the center of the corresponding cross bar at the right side.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a blind body actuator in accordance with an embodiment of the present invention.

FIG. 2 is an exploded view of the blind body actuator in accordance with the embodiment of the present invention.

FIG. 3 to FIG. 5 are schematic partial top views of the embodiment of the present invention, illustrating the lift cord are wound around different cylinder rollers.

FIG. 6 to FIG. 8 are illustrating views of the embodiment of the present invention, illustrating the blind body actuator is actuated.

### DETAILED DESCRIPTION OF THE INVENTION

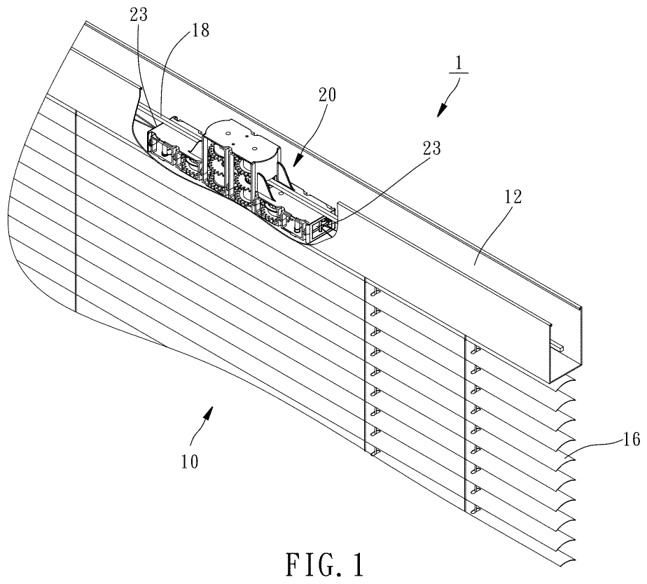

Referring to FIGS. 1, 2 and 6, a blind body actuator 10 in accordance with an embodiment of the present invention is shown. The blind body actuator 10 is used in a non-cord window blind 1. The window blind 1 comprises a headrail 12, a bottom rail 14, and a blind body 16 coupled between the headrail 12 and the bottom rail 14. Further referring to FIG. 1 to FIG. 3, the blind body actuator 10 comprises a casing 20, a winding mechanism 30, a set of lift-cord wheels 40, a set of guide units 50, and a set of lift cords 60.

The casing 20 is mounted in the headrail 12, comprising a top panel 22 and an opposing bottom panel 21 fastened to the top panel 22. The top panel 22 has two opposing through holes 26 for mounting a steering rod 18 of the window blind 1. Further, the casing 20 has two openings 23 defined between the bottom panel 21 and the top panel 22 in each of two lateral sides respectively (i.e. left side and right side of the casing 20), and two cross bar 24 each located in each of the opening 23 and fixedly connected between the bottom panel 21 and the top panel 22 in such a manner that a center of the cross bar 24 coincides with a center of a corresponding one of the opening 23.

The winding mechanism 30 comprises a first upper winding wheel 32a, a second upper winding wheel 32b, a first lower winding wheel 32c, a second lower winding wheel 32d, an upper volute spring 34a, and a lower volute spring 32b. The first upper winding wheel 32a and the second upper winding wheel 32b are juxtaposed (along a direction from the left side to the right side of the casing 20) on the top panel 22 and meshed with each other. The first lower winding wheel 32c and the second lower winding wheel 32d are juxtaposed on the top panel 22 and respectively and coaxially disposed below the first upper winding wheel 32a and the second upper winding wheel 32b. The first lower winding wheel 32c and the second lower winding wheel 32d are meshed with each other. Further, the first upper winding wheel 32a along with the first lower winding wheel 32c are connected with a first wheel axle 28 (so are the second upper winding wheel 32b and the second lower winding wheel 32d) in such a manner that the winding wheels 32a, 32b,32c,32d can rotate synchronously. The upper volute spring 34a has two opposite ends thereof respectively connected to the first upper winding wheel 32a and the second upper winding wheel 32b. Subject to relative rotation between the first upper winding wheel 32a and the second upper winding wheel 32b, the upper volute spring 34a can be fully wound around the first upper winding wheel 32a or the second upper winding wheel 32b. Similarly, the lower volute spring 34b has two opposite ends thereof respectively connected to the first lower winding wheel 32c and the second lower winding wheel 32d. Subject to relative rotation between the first lower winding wheel 32c and the second lower winding wheel 32d, the lower volute spring 34b can be fully wound around the first lower winding wheel 32c or the second lower winding wheel 32d.

The set of the lift-cord wheels 40 comprises a first lift-cord wheel 40a and a second lift-cord wheel 40b, both of which are rotatably mounted between the top panel 22 and the bottom panel 21 of the casing 20 by two corresponding second wheel axles 29. The first lift-cord wheel 40a is meshed with the first lower winding wheel 32c, and the second lift-cord wheel 40b is meshed with the second lower winding wheel 32b so that the first lift-cord wheel 40a is rotatable with the meshed first lower winding wheel 32c synchronously and the second lift-cord wheel 40b is rotatable with the meshed second lower winding wheel 32d synchronously. Further, both of the first lift-cord wheel 40a and the second lift-cord wheel 40b have a partition 41 disposed at a middle thereof. The partition 41 separates two accommodating spaces for winding the corresponding lift cords 60.

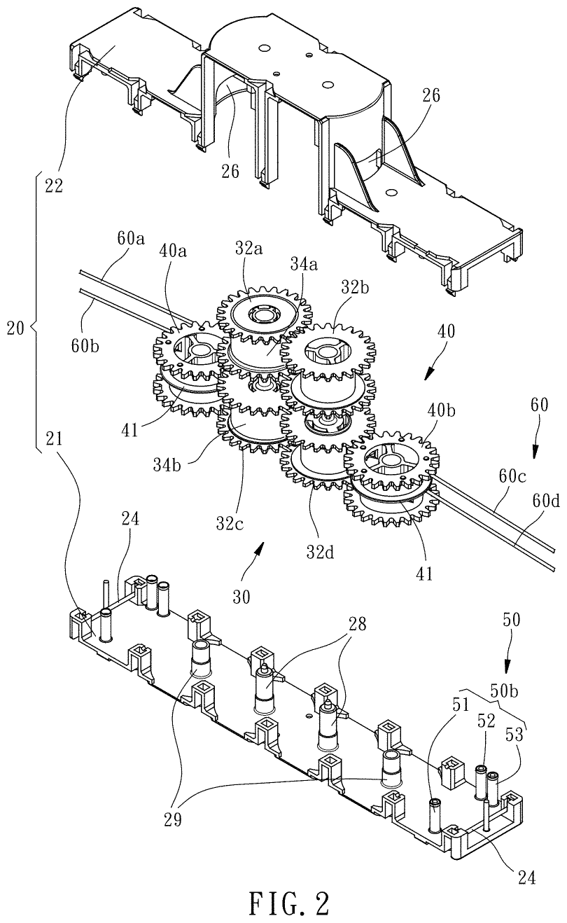

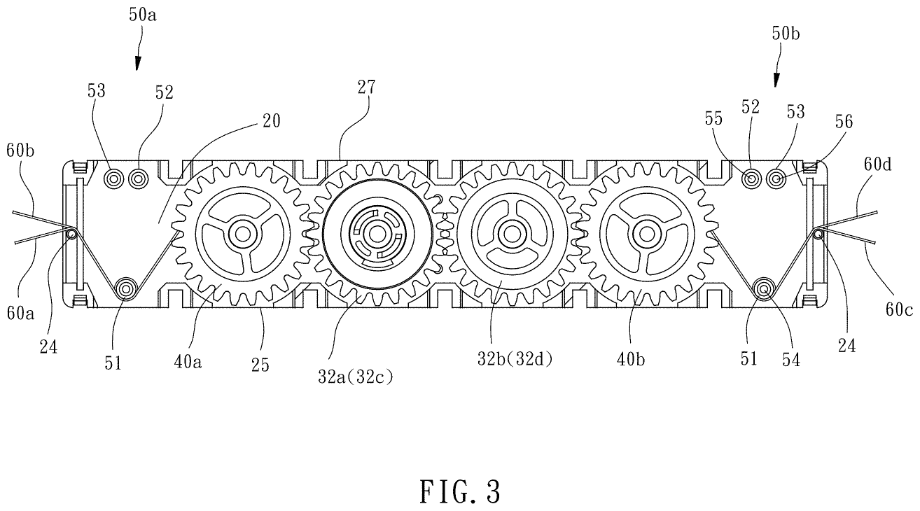

With reference to FIG. 2 and FIG. 3, the set of guide units 50 comprises a first guide unit 50a and a second guide unit 50b, both of which are respectively disposed adjacent to the first lift-cord wheel 40a and the second lift-cord wheel 40b. Both of the first guide unit 50a and the second guide unit 50b have a first cylinder roller 51, a second cylinder roller 52 and a third cylinder roller 53. The first cylinder rollers 51 each are rotatably mounted in the casing 20 and adjacent to a front side 25 of the casing 20 by a corresponding one of the first roller axles 54. The second cylinder rollers 52 each are rotatably mounted in the casing 20 and adjacent to a rear side 27 of the casing 20 by a corresponding one of the second roller axles 55. The third cylinder rollers 53 each are rotatably mounted in the casing 20 and adjacent to the rear side 27 of the casing 20 by a corresponding one of the third roller axles 56 and kept spacedly arranged to the corresponding second cylinder roller 52, The cylinder rollers 51,52,53 are all made of plastic material. Further, the wheel axles 28,29 and the roller axles 54,55,56 are all arranged parallel to each other and all of them are perpendicular to the top panel 22 and the bottom panel 21.

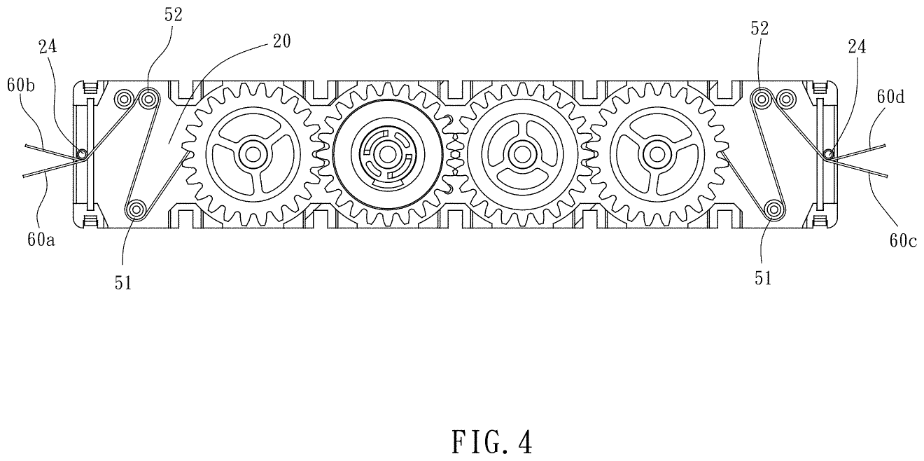

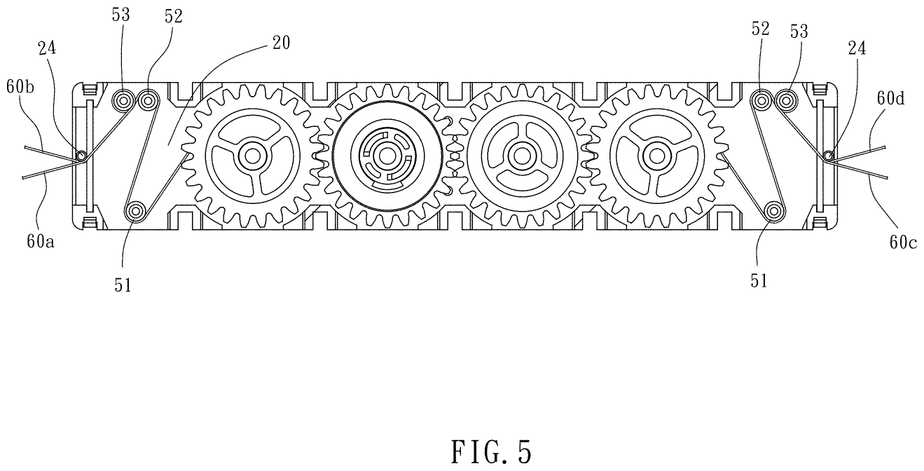

The set of lift cords 60 has two first lift cords 60a,60b and two second lift cords 60c,60d. The two first lift cords 60a,60b each have one end thereof fixedly connected to the first lift-cord wheel 40a and respectively disposed at two sides of the partition 41 of the first lift-cord wheel 40a so that the two first lift cords 60a,60b can be wound or unwound around the first lift-cord wheels 40a by the rotation of the first lift-cord wheels 40a. Hence, the two first lift cords 60a,60b will not intertwine to each other. The two second lift cords 60c,60d each have one end thereof fixedly connected to the second lift-cord wheel 40b and respectively disposed at two sides of the partition 41 of the second lift-cord wheel 40b so that the two second lift cords 60c,60d can be wound or unwound around the second lift-cord wheels 40b by the rotation of the second lift-cord wheels 40b. Hence, the two second lift cords 60c,60d will not intertwine to each other. Further, according to various sizes of different window blinds 1, the user may employ corresponding winding methods to wind the two first lift cords 60a,60b around the cylinder rollers 51,52,53 of the first guide unit 50a. (Similarly, the user may employ corresponding methods to wind the two second lift cords 60c,60d around the cylinder rollers 51,52,53 of the second guide unit 50b.) For example, if a small size window blind 1 is applied as shown in FIG. 3, the two first lift cords 60a,60b (so are the second lift cords 60c,60d) may be wound around the first cylinder roller 51 of the associating guide unit 50a through one turn, passed by the cross bar 24, and then extended out of the casing 20 and connected to the bottom rail 14 of the window blind 1. In the application example of middle size window blind 1 as shown in FIG. 4. the two first lift cords 60a,60b (so are the second lift cords 60c,60d) may be wound around the first cylinder roller 51 of the associating guide unit 50a through half turn, wound around the second cylinder roller 52 of the associating guide unit 50a through half turn, passed by the cross bar 24, and then extended out of the casing 20 and connected to the bottom rail 14 of the window blind 1. In the application example of large size window blind 1 as shown in FIG. 5, the two first lift cords 60a,60b (so are the second lift cords 60c,60d) may be wound around the first cylinder roller 51 of the associating guide unit 50a through half turn, wound around the second cylinder roller 52 of the associating guide unit 50a through half turn, wound around the third cylinder roller 53 of the associating guide unit 50a through one turn, passed by the cross bar 24, and then extended out of the casing 20 and connected to the bottom rail 14 of the window blind 1. In any one of the aforesaid various winding methods, the lift cords 60a,60b will be abutted against the center of the cross bars 24 (located at the left side) of the casing 20 when extended out of the corresponding openings 23, the lift cords 60c,60d will be abutted against the center of the cross bars 24 (located at the right side) of the casing 20, thus enhancing the stability of the actuation of the blind body actuator 10.

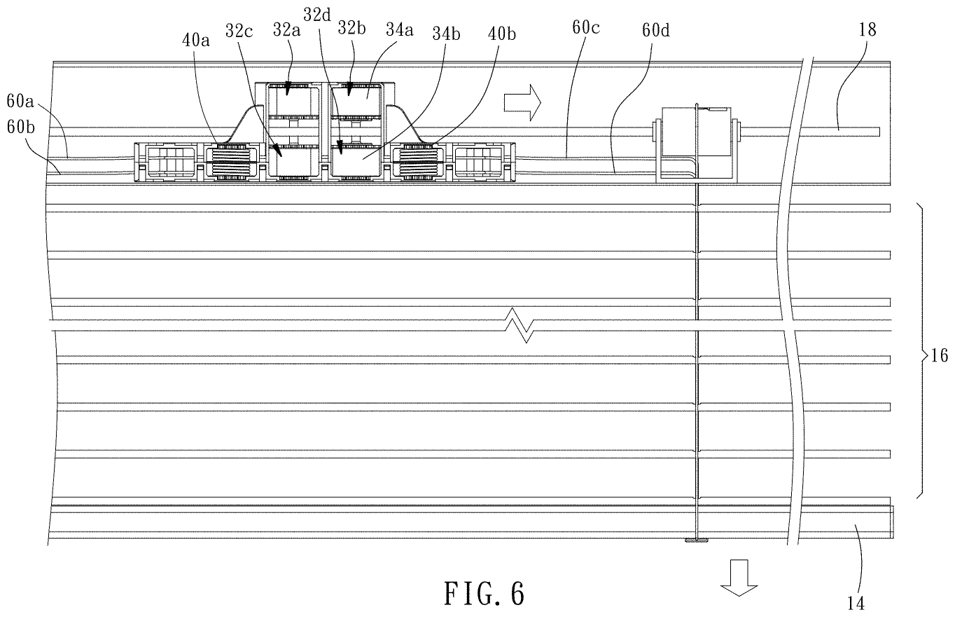

Based on the abovementioned structure of the blind body actuator 10, when the user wants to extend out the blind body 16 (shown in FIG. 6), the user can downward pull the bottom rail 14 to drive the first lift-cord wheel 40a and the second lift-cord wheel 40b to rotate via the set of the lift cords 60 (including the lift cords 60a,60b,60c,60d). The first and second lift-cord wheels 40a,40b are accordingly rotated and cause the rotation of the meshed first lower winding wheels 32c and the meshed second lower winding wheel 32d. At this time, the first upper winding wheel 40a and the second upper winding wheel 40b will be accordingly rotated as well. Thus, the upper and lower volute spring 34a,34b are both unwound to store elastic force. After the user fully extends out the blind body 16, then the user can stop exerting pulling force to the bottom rail 14. At this tune, the gravitational three of the bottom rail 14 and the stored elastic force of the upper and lower volute springs 34a, 34b are maintained in static balance, and thus, the blind body 16 is held in an extended state.

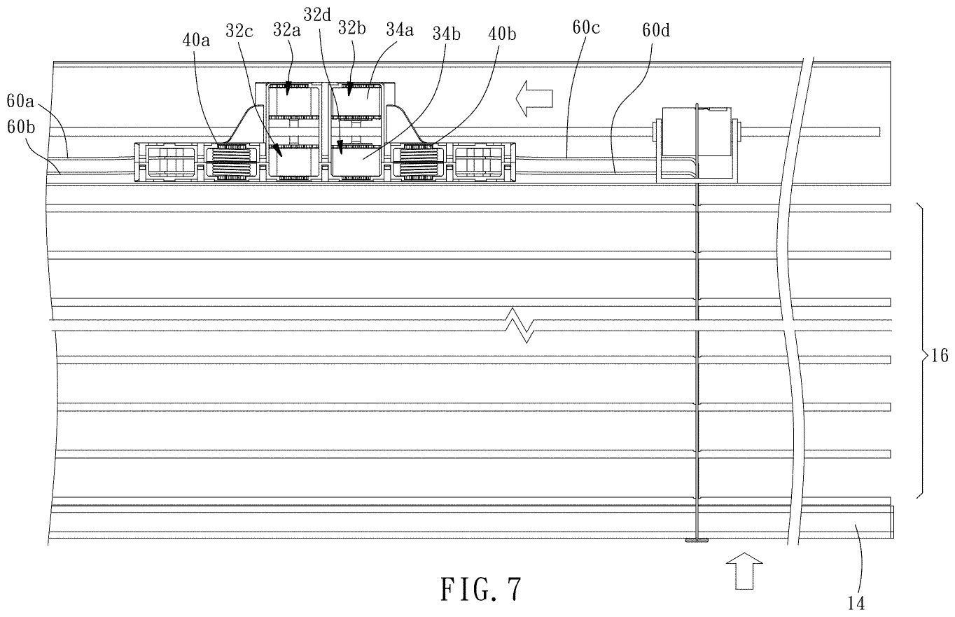

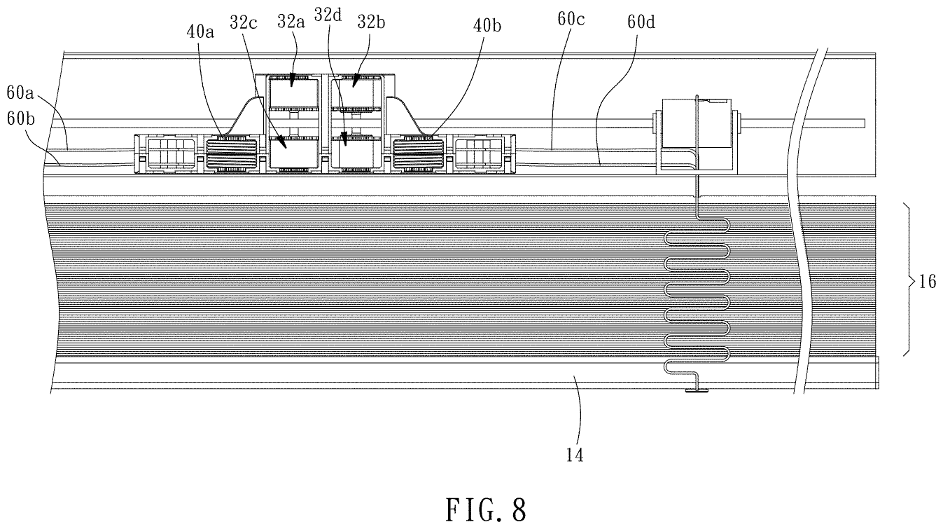

When the user wants to receive the blind body 16 (as shown in FIG. 7), the user needs to push the bottom rail 14 upward. At this time, the gravitational force of the bottom rail 14 is canceled by the pushing force. The winding wheels 32a,32b,32c,32d will start to rotate reversely and synchronously by the stored elastic force of the upper and lower volute springs 34a, 34b. During the reverse rotation, the winding wheels 32a,32b,32c,32d will drive the meshed first and second lift-cord wheel 40a,40b to wind around the corresponding lift cords 60a, 60b,60c,60d. Once the blind body 16 is fully received, the user can stop exerting pushing force to the bottom rail 14. At this time, the gravitational three of the bottom rail 14 and the elastic three of the volute spring 34 are maintained in static balance again. Thus, the blind body 16 is held in a received state.

Either in the process of extending out the blind body 16 or receiving the blind body 16, the cylinder rollers 51,52,53 of the guide units 50a,50b can be driven to rotate by the corresponding lift cords 60 by means of the friction force generated therebetween, enhancing the stability and smoothness of the actuation of the lift cords 60, and thus, the overall operation process can achieve optimal actuation effects.

What is claimed is:

1. A blind body actuator for non-cord window blind assembly, comprising:
a casing;
a winding mechanism rotatably mounted in said casing and comprising a first bottom winding wheel, a first upper winding wheel disposed on said first bottom winding wheel, a second bottom winding wheel meshed with said first bottom winding wheel, and a second upper winding wheel disposed on said second bottom winding wheel and meshed with said first upper winding wheel, said winding mechanism further comprising an upper volute spring and a bottom volute spring, said upper volute spring having two ends thereof connected with said first and second upper winding wheel respectively and being capable of wound around said first upper winding wheel or said second upper winding wheel, said bottom volute spring having two ends thereof connected to said first and second bottom winding wheel respectively and being capable of being wound around said first bottom winding wheel or said second bottom winding wheel;
a set of lift-cord wheels, being rotatably mounted in said casing and comprising a first lift-cord wheel and a second lift-cord wheel, said first lift-cord and said second lift-cord being respectively meshed with said first bottom winding wheel and said second bottom winding wheel;
a set of guide units, being rotatably mounted in said casing and comprising a first guide unit and a second guide unit, said first guide unit and said second guide unit being respectively disposed adjacent to said first lift-cord wheel and said second lift-cord wheel, said first and second guide units both comprising a first cylinder roller, each of said first cylinder rollers, said first and second winding wheels, and said first and second lift-cord wheels having an axle respectively, and said axles of said first cylinder rollers, said first and second winding wheels, and said first and second lift-cord wheels being parallel to each other; and
a set of lift cords, comprising two first lift cords and two second lift cords, said two first lift cords and said two second lift cords being respectively wound around said first cylinder roller of said first guide unit and said first cylinder roller of said second guide unit respectively, each of said two first lift cords having one end thereof connected to said first lift-cord wheel so that each of said first lift cords are capable of being wound around or unwound around said first lift-cord wheel by said rotation of said first lift-cord wheel, each of said two second lift cords having one end thereof connected to said second lift-cord wheel so that each of said first lift cords are capable of being wound around or unwound around said second lift-cord wheel by the rotation of said second lift-cord wheel, each of said first lift cords and said second lift cords having an opposite end thereof extended out of said casing.

2. The blind body actuator as claimed in claim 1, wherein said casing has a front side and a rear side; said two first cylinder rollers are disposed adjacent to said front side of said casing; each of said first lift cords are wound around said first cylinder roller of said first guide unit through one turn and each of said second lift cords are wound around said first cylinder roller of said second guide unit through one turn.

3. The blind body actuator as claimed in claim 1, wherein both of said first and second guide units further comprise a second cylinder roller rotatably mounted in said casing; said casing has a front side and a rear side; said two first cylinder rollers and said two second cylinder rollers of said first and second guide units are respectively disposed adjacent to said front side and said rear side of said casing respectively; said two first lift cords are wound around said first cylinder roller of said first guide unit through half turn and then wound around said second cylinder roller of said first guide unit through half turn; said two second lift cords are wound around said first cylinder roller of said second guide unit through half turn and then wound around said second cylinder roller of said second guide unit through half turn.

4. The blind body actuator as claimed in claim 1, wherein said first guide unit and said second guide unit both further comprise a second cylinder roller and a third cylinder roller; said casing comprises a front side and a rear side; said two second cylinder rollers and said two third cylinder rollers are rotatably mounted in said casing; said two first cylinder rollers are mounted adjacent to said front side; said two second cylinder rollers and said two third cylinder rollers are juxtaposed and mounted adjacent to said rear side; said two first lift cords are wound around said first cylinder roller of said first guide unit through half turn, wound around said second cylinder roller of said first guide unit through half turn, and then wound around said third cylinder roller of said first guide unit through one turn; said two second lift cords are wound around said first cylinder roller of said second guide unit through half turn, wound around said second cylinder roller of said second guide unit through half turn, and then wound around said third cylinder roller of said second guide unit through one turn.

5. The blind body actuator as claimed in claim 1, wherein said casing comprises a left side and a right side, both of which has an opening and a cross bar disposed in the corresponding said opening in such a manner that a center of said cross bar coincides with a center of the corresponding opening; said two first lift cords are extended out of said casing through said opening and peripherally abutted against said center of the corresponding cross bar at said left side; said two second lift cords are extended out of said casing through said opening and peripherally abutted against said center of the corresponding said cross bar at said right side.
